(19) United States
(12) Patent Application Publication
(10) Pub. No.: US 2005/0210752 A1
(43) Pub. Date: Sep. 29, 2005

(54) Drive tension sensor for a powered door

(76) Inventor: Peter S. Schulte, East Dubuque, IL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/800,907

(22) Filed: Mar. 15, 2004

(51) Int. Cl. E05B 15/02

(52) U.S. Cl. 49/360

(57) ABSTRACT

A horizontally sliding door or some other type of translating door includes a chain, cable, or some other elongate member for moving a door panel across a doorway, and the door also includes a sensor that monitors the tension or slackness of the elongate member to determine whether the door panel encounters an obstruction in the doorway. In some embodiments, a proximity sensor detects slackness in the elongate member by sensing when the member droops away from or toward the sensor. The elongate member can have some sections that are more elastic than others to increase the drooping action.

### BACKGROUND OF THE INVENTION

1. Field of the Invention

The subject invention generally pertains to powered doors and more specifically to a system for sensing if the door strikes an obstruction.

2. Description of Related Art

Power-operated translating doors often have a drive unit connected to a door panel by way of a chain, cable, belt, strap, or some other type of elongate member. The drive unit's direction of rotation determines whether the elongate member moves the door panel to an open or closed position. Depending on the style of door, there may be one or more panels that move vertically or horizontally across the doorway. Concertina style doors have a series of pivotally interconnected door panels that fold or unfold as the elongate member pulls one of the panels across the doorway.

To avoid damage or injury caused by a door accidentally closing against an obstruction in the doorway, the door may include a sensor that detects when a leading edge of a door panel encounters such an obstruction. In response to the sensor, the door's drive unit could stop or reverse the movement of the door panel.

There are many different types of door sensors for achieving generally the same purpose. Some of the more common sensors include pneumatic safety edges, electric safety edges and motor current sensors.

Pneumatic safety edges and electric safety edges are installed along a door panel's leading edge (i.e., the edge that leads the panel's movement across the doorway). Pneumatic safety edges typically comprise a resiliently flexible, fluid-filled tube. Temporarily crushing the tube between an obstruction and the leading edge of the door panel raises the fluid pressure in the tube. The rise in pressure can then be used for creating a signal that commands the drive unit to stop or reverse direction.

Electric safety edges typically comprise two spaced-apart electrical conductors that extend along the door panel's leading edge. When an obstruction forces the two conductors together, the resulting electrical short between the two can provide a signal that commands the drive unit to stop or reverse direction.

Both pneumatic and electric safety edges often extend into the traffic path of the doorway, so they tend to get damaged by forklifts and other passing vehicles.

For sensors that monitor the motor current to the drive unit, a sufficient rise in current helps determine whether a door panel has encountered an obstruction. Although motor current sensors are not usually exposed to traffic, they can be difficult to adjust to a precise set point, and they can have low repeatability due to motor currents that are notoriously unstable. Also, motor current sensor systems can be expensive.

### SUMMARY OF THE INVENTION

In some embodiments, the closing force of a translating door panel is sensed by monitoring the tension or slackness of an elongate member that moves the door panel between its open and closed positions.

In some embodiments, a drive unit stops or reverses the movement of a door panel in response to the door's drive chain (or other elongate member) decreasing to a certain limit.

In some embodiments, a drive unit stops or reverses the movement of a door panel in response to the door's drive chain (or other elongate member) increasing to a certain limit.

In some embodiments, slackness in a door's drive chain is detected by a proximity sensor next to the chain.

In some embodiments where an elongate member moves a door panel, variations in the slackness of the elongate member is accentuated by having a portion of the elongate member be more stretchable than other portions.

In some embodiments where an elongate member moves a door panel, variations in the slackness of the elongate member is accentuated by connecting the elongate member to a spring.

In some embodiments where an elongate member moves a door panel, a sensor mounted inline with the elongate member senses tension therein.

In some embodiments where an elongate member moves a door panel, a sensor monitors changes in length of the elongate member.

In some embodiments where an elongate member moves a door panel, a sensor monitors translation of a spring-loaded wheel that supports the elongate member.

In some embodiments, where an elongate member moves two separate door panels in opposite directions, a sensor monitors the tension in the elongate member for determining whether either panel has encountered an obstruction.

In some embodiments, a door encountering an obstruction is detected by monitoring the motor voltage of a DC motor that drives the door.

### BRIEF DESCRIPTION OF THE DRAWINGS

FIG. 1 is a front view of an open door that includes a sensor system for detecting whether the door is obstructed.

FIG. 2 is a front view of the door shown FIG. 1 but showing the door partially closed.

FIG. 3 is a front view of the door shown in FIG. 1 but showing the door closed.

FIG. 4 is similar to FIG. 2 but showing an obstruction that is preventing the door from closing.

FIG. 5 is a front view similar to FIG. 2 but showing another embodiment of a door.

FIG. 6 is a front view similar to FIG. 4 but showing the door of FIG. 5.

FIG. 7 is a front view similar to FIG. 2 but showing another embodiment of a door.

FIG. 8 is a front view similar to FIG. 4 but showing the door of FIG. 7.

FIG. 9 is a front view similar to FIG. 4 but showing another embodiment of a door.

FIG. 10 is a front view similar to FIG. 4 but showing yet another embodiment of a door.

FIG. 11 is a front view similar to FIG. 2 but showing still yet another embodiment of a door.

FIG. 12 is similar to FIG. 11 but showing an obstruction that is preventing the door from closing.

FIG. 13 is a wiring schematic of a circuit that identifies an overload condition of a door driven by a DC motor.

### DESCRIPTION OF THE PREFERRED EMBODIMENT

Although the invention is described with reference to doors having one or more horizontally translating door panels, it should be appreciated by those skilled in the art that the invention is readily adapted for various other types of doors including, but not limited to, rollup doors (those whose rollup curtain or panels are supported by a cable or some other elongate member), overhead storing doors, vertically moving doors, concertina doors, etc.

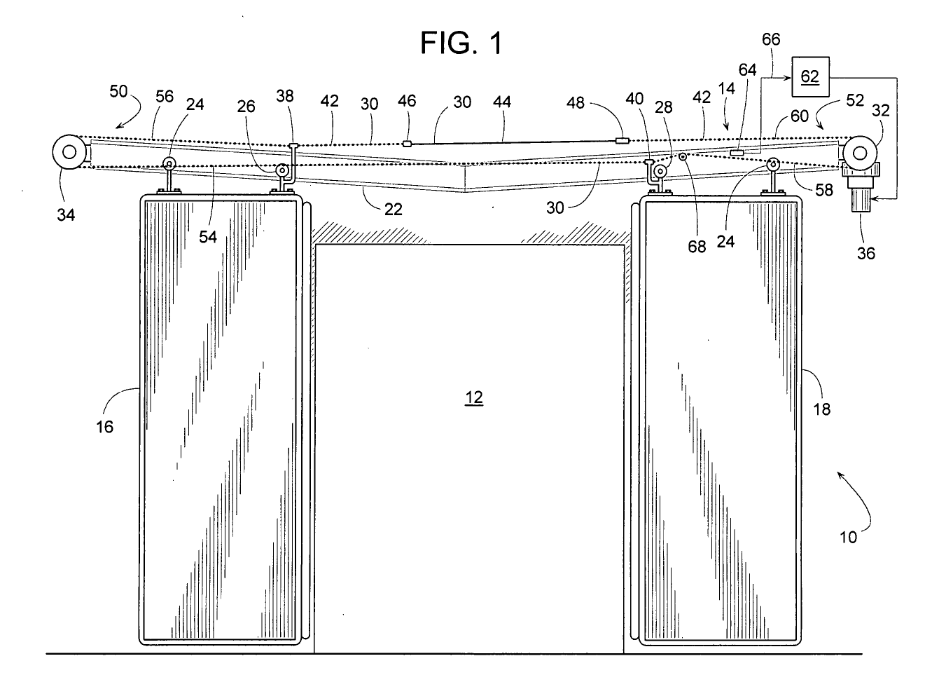

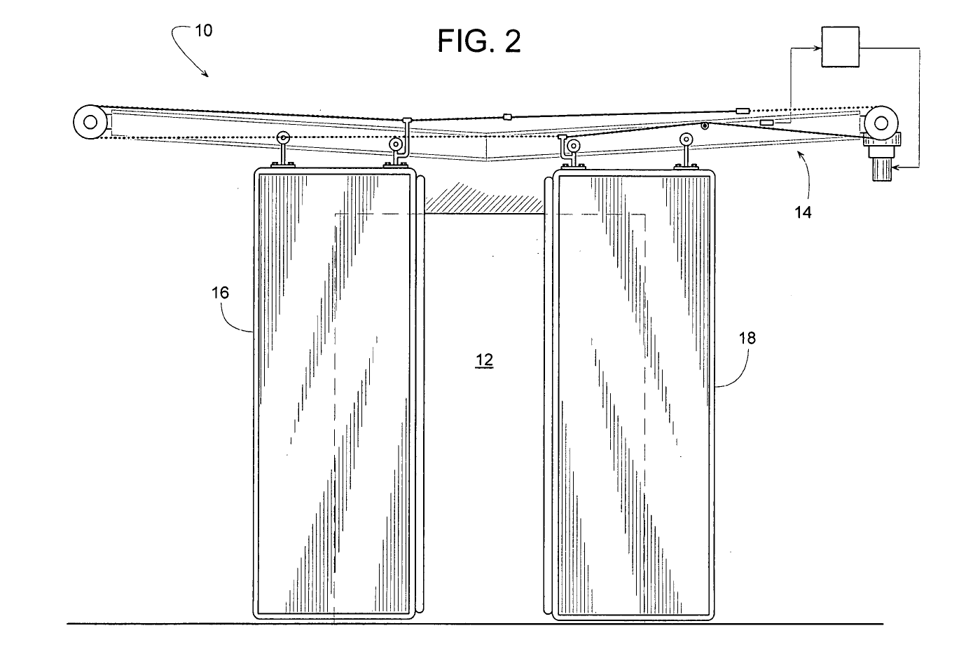

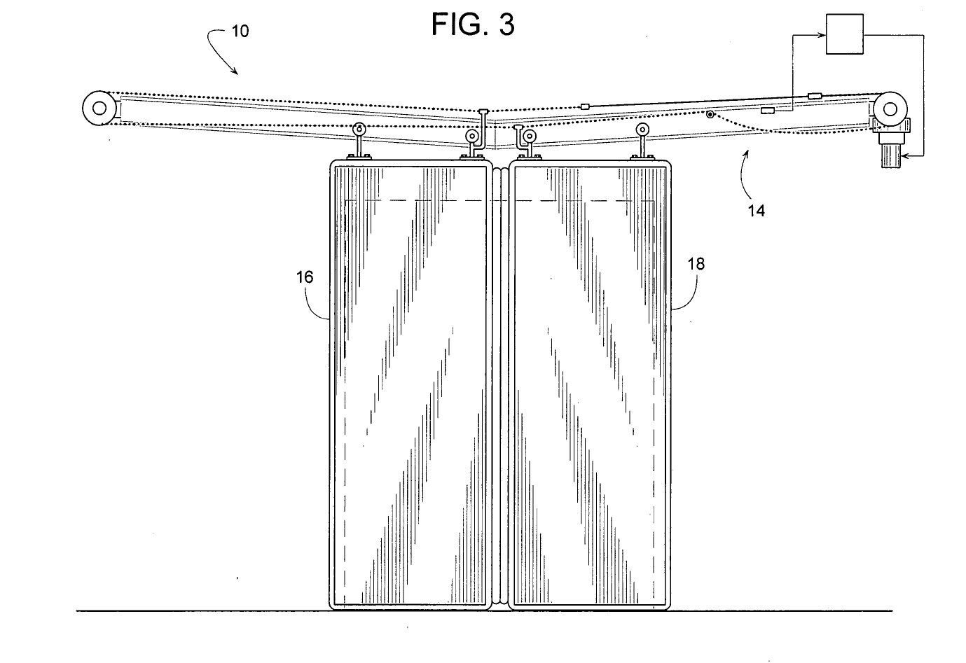

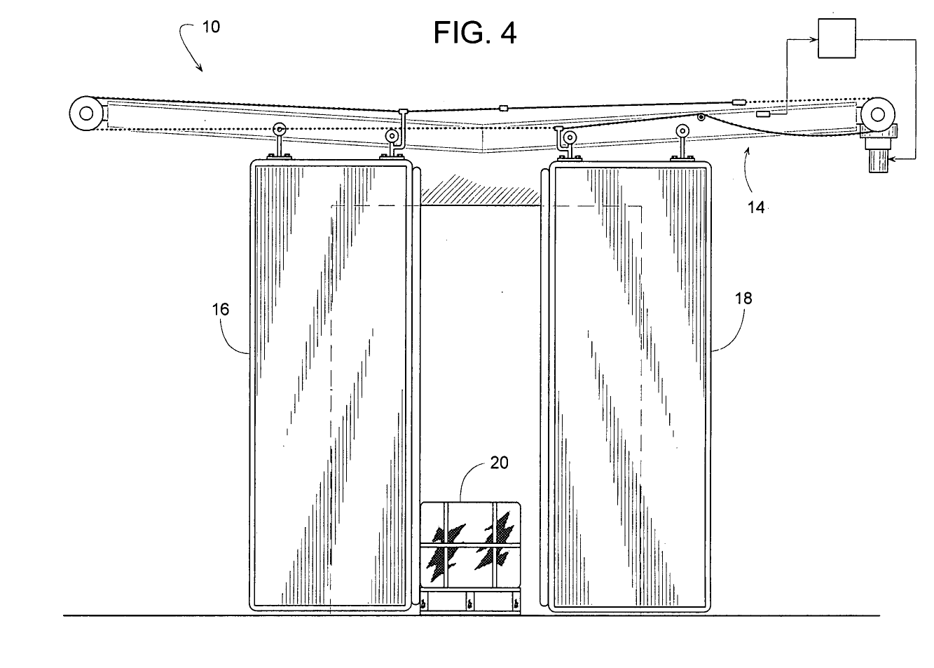

A dual-panel, horizontally sliding door 10 is shown fully open in FIG. 1, partially closed in FIG. 2, fully closed in FIG. 3, and obstructed in FIG. 4. The term, “sliding” broadly refers to sliding, rolling, or any other translating motion relative to a doorway 12. Door 10 includes a sensor system 14 for detecting when either of its two door panels 16 or 18 encounters an obstruction 20 (FIG. 4) or meets each other near the center of the doorway (FIG. 3).

An overhead track 22 suspends panels 16 and 18 by way of trolleys 24, 26 and 28, or by way of some other track-following member attached to panels 16 and 18. To move the panels across the doorway, door 10 includes a flexible elongate member 30 looped about a right-hand wheel 32 and a left-hand wheel 34. The flexible elongate member could be a chain, cogged belt, smooth belt, cord, cable, strap, belt, and/or various combinations thereof. Wheels 32 and 34 can be of any design suitable for supporting elongate member 30. Examples of wheels 32 and 34 include, but are not limited to, a pulley, sheave, sprocket, drum, etc. A motorized drive unit 36 powers the rotation of right-hand wheel 32 to move elongate member 30, and left-hand wheel 34 is an idler wheel that rotates in response to the elongate member's movement. One clamp 38 couples trolley 26 of panel 16 to move with an upper portion of elongate member 30, and another clamp 40 couples trolley 28 of panel 18 to move with a lower portion of elongate member 30. Thus, the drive unit's direction of rotation determines whether panels 16 and 18 move together to close the door or apart to open it.

In some embodiments, elongate member 30 comprises a roller chain 42 and a nylon strap 44 that are coupled to each other by way of two couplings 46 and 48. One of the couplings (e.g., coupling 48) can be a conventional ratchet-tightening strap binder so that the length of strap 44 and thus the total length of elongate member 30 can be adjusted. In this case, wheels 32 and 34 are sprockets, and only the chain portion of member 30 travels across them.

The ability of sensor system 14 to detect when a door panel has encountered an obstruction can be enhanced by having strap 44 be more elastic or more stretchable than chain 42. The reason for this will be understood with a description of how sensor system 14 operates. But first, various sections of elongate member 30 will be labeled so that the operation of system 14 can be clearly explained.

Referring to FIG. 1, elongate member 30 includes a left-hand loop 50 supported by left-hand wheel 34 and a right-hand loop 52 supported by right-hand wheel 32. The left-hand loop 50 includes a left-hand closing leg 54 and a left-hand opening leg 56. Similarly, the right-hand loop 52 includes a right-hand opening leg 58 and a right-hand closing leg 60. Clamp 40 on door panel 18 couples the left-hand closing leg 54 to the right-hand opening leg 58, and clamp 38 on door panel 16 couples the left-hand opening leg 56 to the right-hand closing leg 60. Thus, elongate member 30 can be considered as having four sections or legs whose positions and lengths may vary as drive unit 36 moves the door panels across the doorway.

To operate door 10, a conventional controller 62 (well known to those of ordinary skill in the art) commands drive unit 36 to selectively operate in an opening mode, a closing mode, or a stop mode. Controller 62 is schematically illustrated to represent anything than can control the operation of drive unit 36. Examples of controller 62 include, but are not limited to, an electromechanical relay circuit, PLC (programmable logic controller), computer, microprocessor, analog/digital circuit, and various combinations thereof.

In the opening mode, drive unit 36 turns right-hand wheel 32 counterclockwise, which creates greater opening tension in opening legs 56 and 58 than closing tension in closing legs 54 and 60, so panels 16 and 18 move apart to open the door.

In the closing mode, drive unit 36 turns right-hand wheel 32 clockwise, which creates greater closing tension in closing legs 54 and 60 than opening tension in opening legs 56 and 58, so panels 16 and 18 move toward each other to close the door. In the stop mode, drive unit 36 is inactive, so the door panels remain stationary.

When panel 16 or 18 encounters an obstruction 20 (FIG. 4), continued clockwise rotation of wheel 32 increases the tension in right-hand closing leg 60. When panel 18 encounters an obstruction, or the panels meet each other near the center of the doorway (FIG. 3), continued clockwise rotation of wheel 32 increases the tension in both closing legs 54 and 60. In either case, the increased tension in the closing legs 54 and 60 stretches that portion of elongate member 30 (particularly strap 44, which is more elastic). The stretching decreases the tension (or increases the slack) in the right-hand opening leg 58. Sensor system 14 can use this decrease in tension or increase in slackness to identify when one of the panels is obstructed.

In some embodiments, system 14 includes a proximity sensor 64 that senses the proximity of the right-hand opening leg 58. This can be accomplished in an assortment of ways including, but not limited to, using a metal-detecting proximity sensor that detects the presence of metal roller chain elements of elongate member 30, an electromechanical limit switch apparatus that touches member 30, or a photoelectric eye that views the position of member 30.

When door 10 is open (FIG. 1) or moving freely (FIG. 2), then the right-hand opening leg 58 is sufficiently taut to lie adjacent to sensor 64. However, when an obstruction is encountered, as shown in FIG. 4, the resulting slackness of right-hand opening leg 58 allows leg 58 to droop away from sensor 64. Sensor 64 reacts by providing an overload signal 66 that controller 62 uses to stop or reverse the rotation of drive unit 36, whereby the closing action of the door is stopped and preferably changed to the opening mode.

When the two panels abut each near the center of the doorway (FIG. 3), the reduced tension or slackness of right-hand opening leg 58 can be used by sensor 66 to generate a stop signal that commands drive unit 36 to leave the door panels at their closed position. Controller 62 may call on an additional sensor to determine whether the door panels are nearly closed, whereby controller 62 can decide whether to stop or open the door (i.e., determine whether the door is closed or has struck an obstruction). Such an additional sensor may simply be a conventional electromechanical limit switch that detects when panel 16 or 18 are near the center of the doorway.

Although sensor 66 is shown being above right-hand opening leg 58, sensor 64 could just as well be installed beneath leg 58. Then, slackness in right-hand opening leg 58 would move leg 58 toward sensor 64, and controller 62 could be set up to interpret that action as being indicative of a panel striking an obstruction.

In some cases, an idler wheel 68 can support a portion of right-hand opening leg 58 to help keep the remaining drooping portion of leg 58 in the vicinity of sensor 64. For a given change in tension in elongate member 30, idler wheel 68 allows more drooping motion to occur in the area of sensor 64.

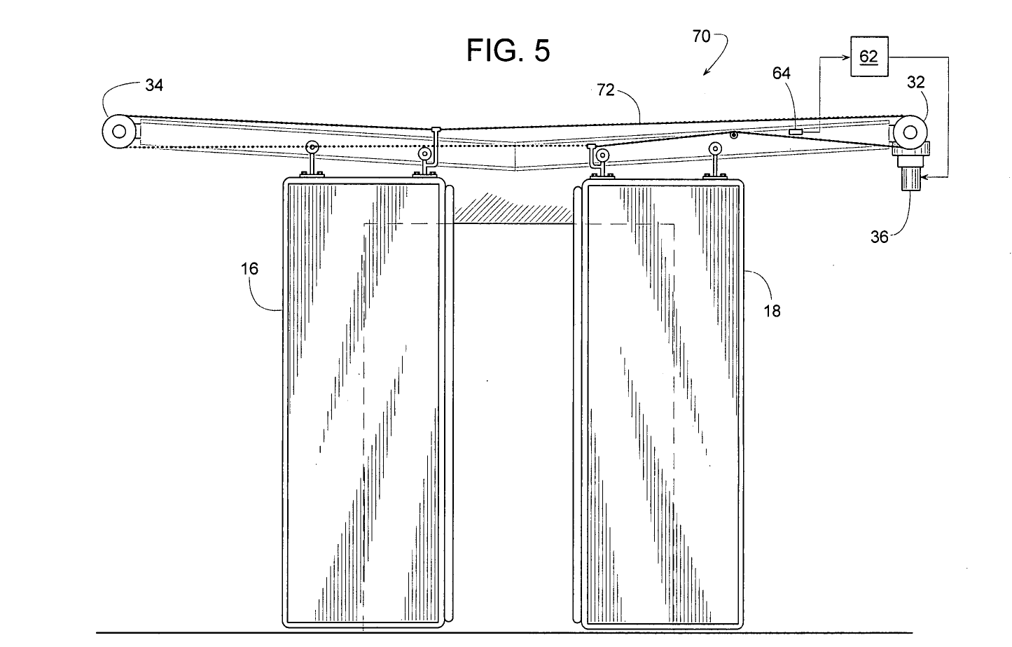

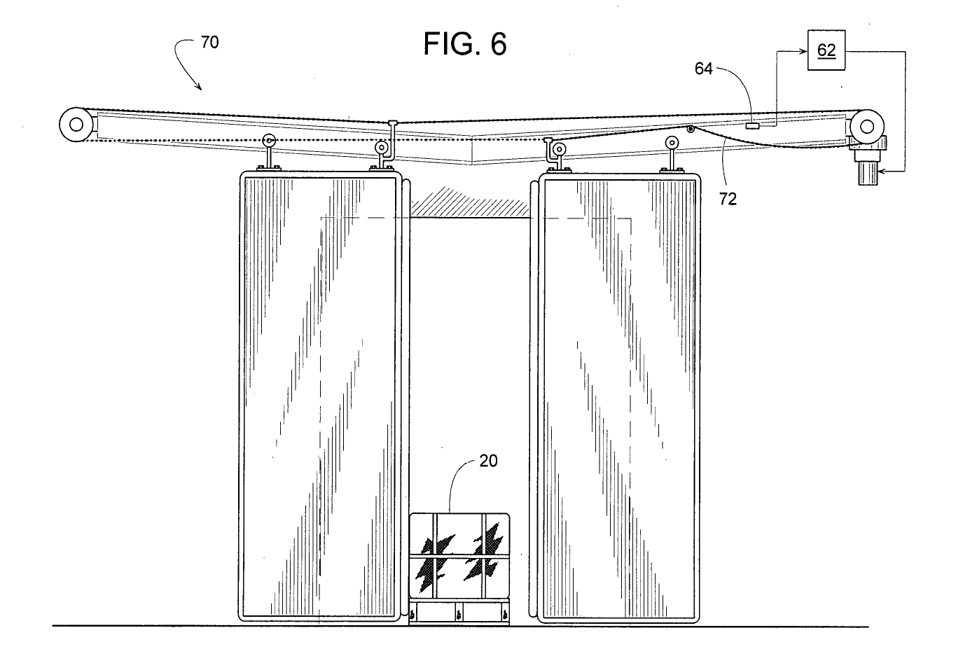

FIGS. 5 and 6 show a door 70 that is the same as door 10, except the strap 44 of elongate member 30 has been replaced by simply lengthening the rest of the elongate member to create elongate member 72. FIGS. 5 and 6 correspond to FIGS. 2 and 4 respectively. With door 70, the elasticity of the chain or other material of elongate member 72 is sufficient in itself to vary the slackness of member 72 in the area of sensor 64.

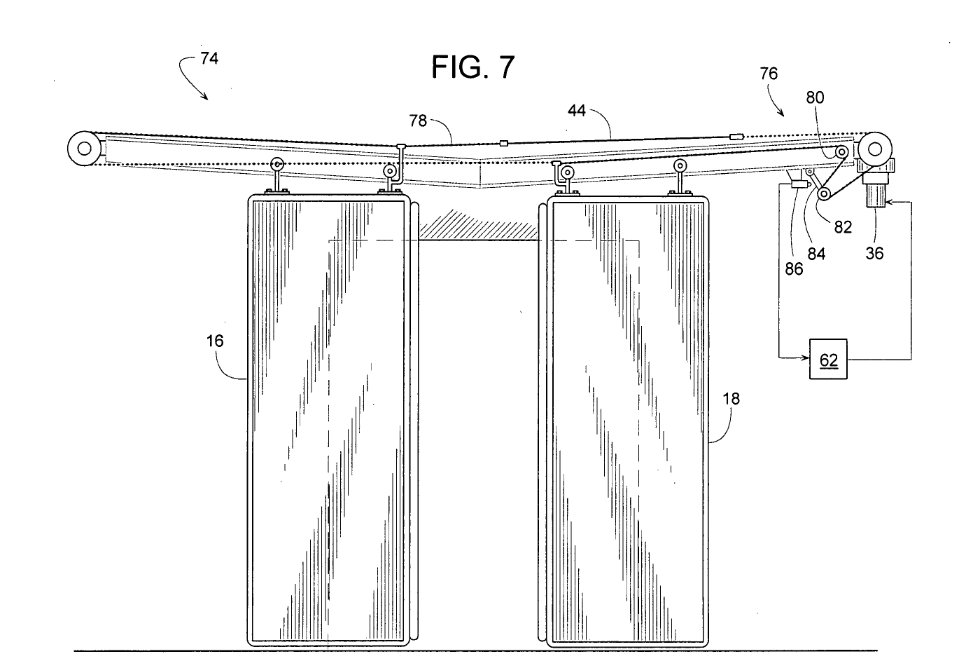

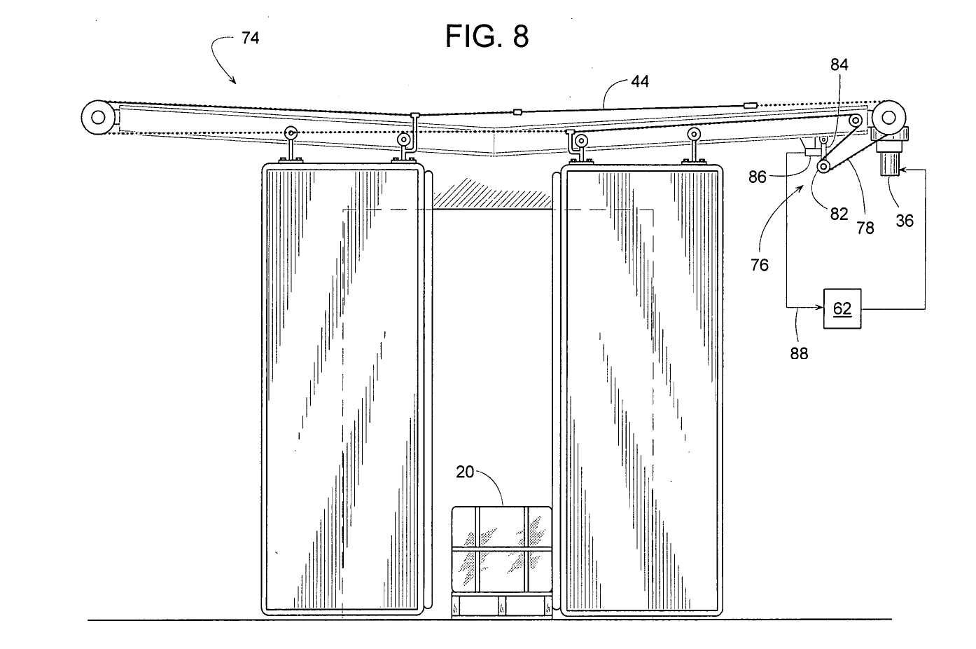

FIGS. 7 and 8, which also correspond to FIGS. 2 and 4 respectively, show a door 74 that uses a different sensor system 76 for sensing the tension in an elongate member 78. System 76 includes a generally stationary idler wheel 80 and a spring-loaded idler wheel 82 that translates to take up any slack in elongate member 78. In this example, a pivot arm 84 enables wheel 82 to translate as the tension varies the stretching of elongate member 78. A torsion spring or some other type of spring or biasing device urges arm 84 clockwise toward a conventional plunger-style limit switch 86.

When there's no obstruction, as shown in FIG. 7, the length of elongate member 78 is of normal length so that member 78 can hold wheel 82 and arm 84 away from switch 86. When door 74 hits an obstruction, as shown in FIG. 8, drive unit 36 stretches strap 44, which increases the total length of elongate member 78. The increased length allows arm 84 to swing against limit switch 86. Switch 86 responds by creating an overload signal 88 that controller 62 uses to stop or reverse drive unit 36. Although the translation of wheel 82 is through the pivotal motion of arm 84, it should be clear to those skilled in the art that numerous other translating mechanisms could accomplish the same result.

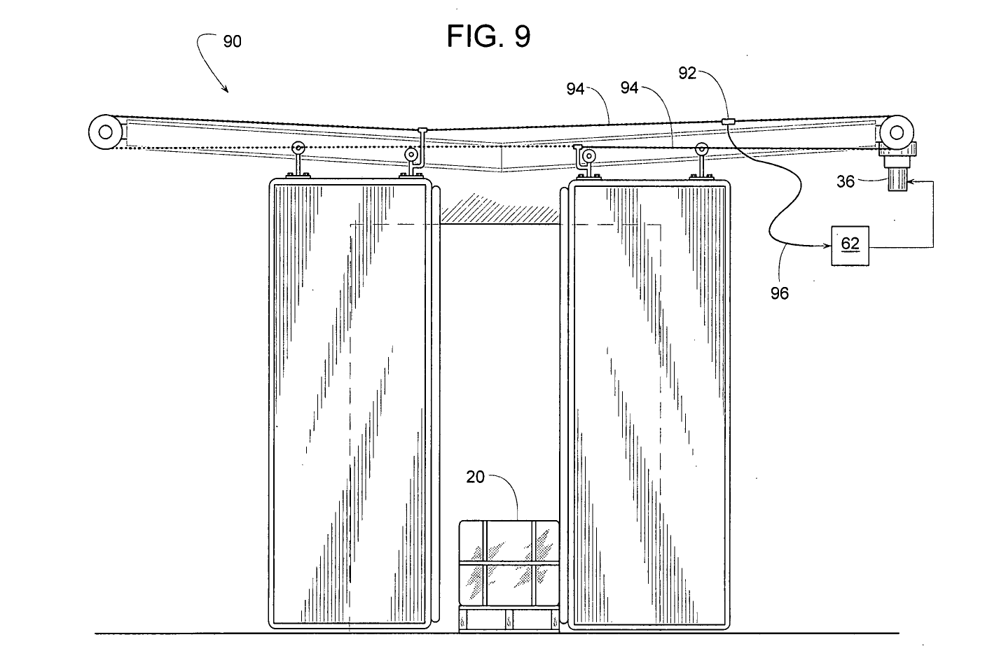

In FIG. 9, a door 90 includes a sensor 92 in the form of a strain gage, piezoelectric sensor, load cell, or some other type of sensor that can sense the tension in an elongate member 94. Sensor 92 is preferably installed inline with elongate member 94 and can be attached at any suitable location where the tension in member 94 could indicate whether door 90 encounters an obstruction. In response to detecting a predetermined change in tension, sensor 92 could provide controller 62 with an overload signal 96 that stops or reverses drive unit 36.

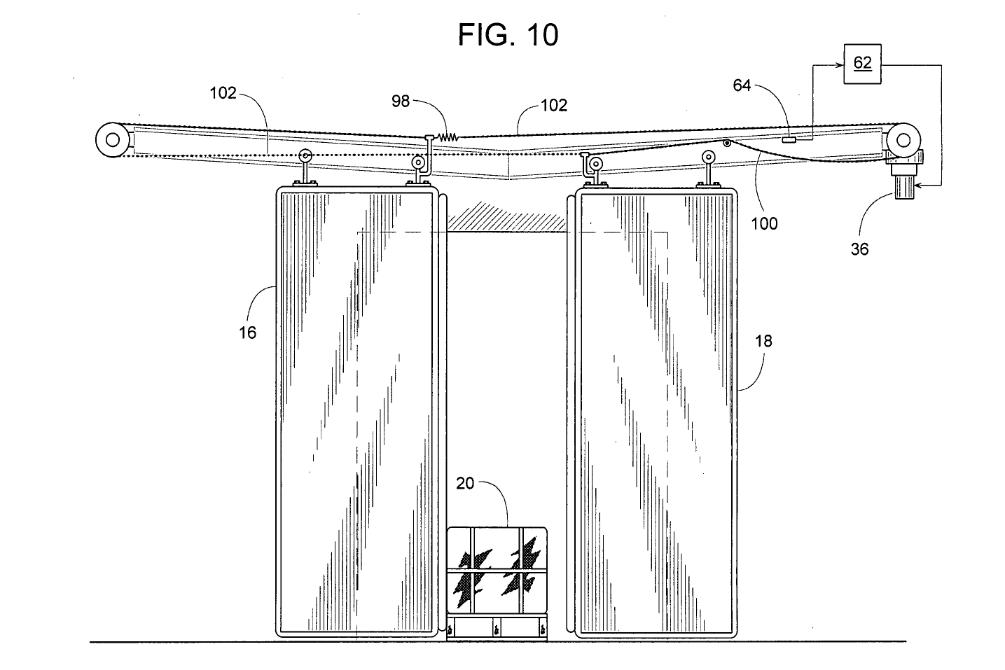

FIG. 10 is similar to door 10 of FIG. 4, except strap 44 of elongate member 30 has been replaced by a spring 98. Spring 98 can be a tension spring or some other resilient member that renders a right-hand closing leg 100 of elongate member 102 more elastic than the rest of member 102.

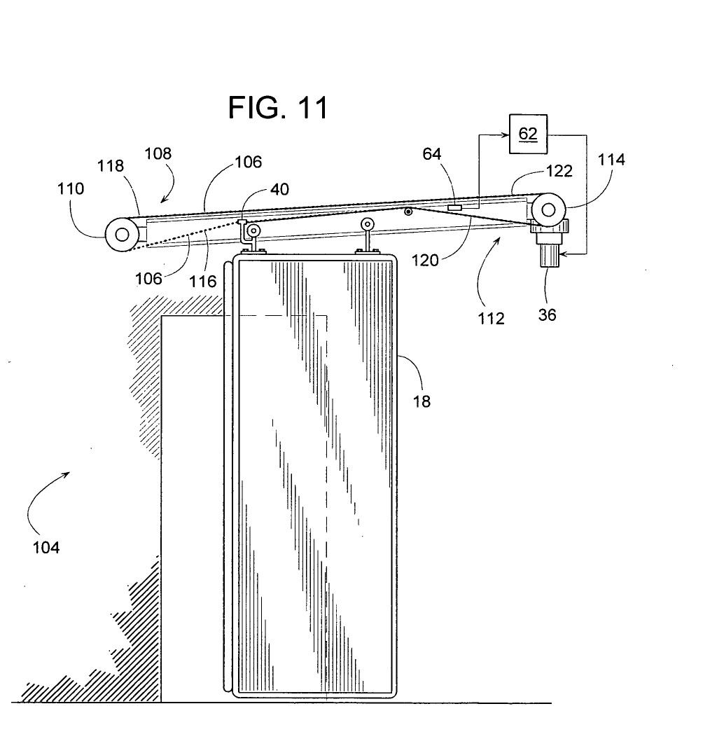

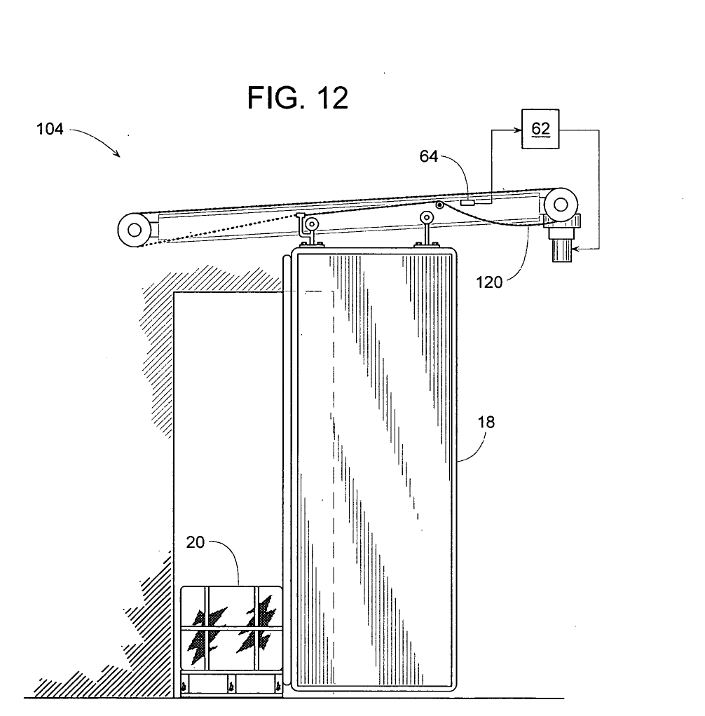

FIGS. 11 and 12 show a simpler door 104 that has only one door panel 18. In this example, an elongate member 106 includes a left-hand loop 108 supported by left-hand wheel 110 and a right-hand loop 112 supported by right-hand wheel 114. The left-hand loop 108 includes a left-hand closing leg 116 and a left-hand opening leg 118. Similarly, the right-hand loop 112 includes a right-hand opening leg 120 and a right-hand closing leg 122. Clamp 40 on door panel 18 couples the left-hand closing leg 116 to the right-hand opening leg 120, and the left-hand opening leg 118 and the right-hand closing leg 122 connect to each other at some arbitrary point between wheels 110 and 114. The operation of door 104 is similar to that of door 70 with FIGS. 11 and 12 corresponding to FIGS. 5 and 6 respectively.

Drive unit 36 may include any type of prime mover such as an AC or DC motor. For AC motors, a current sensor can be used to determine when a door panel encounters an obstruction, since an AC motor's current increases with load or the mechanical resistance applied to the door.

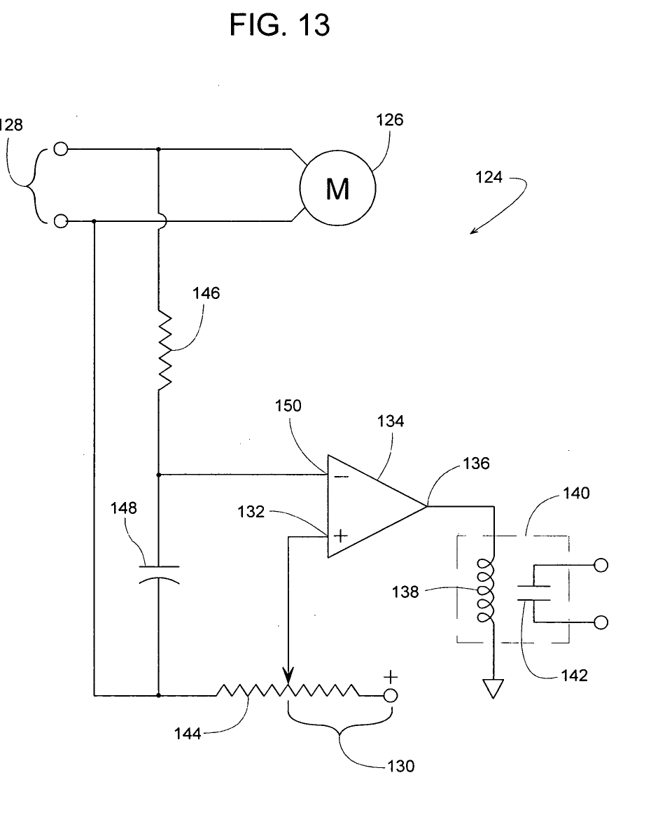

For DC motors, the winding voltage is a linear correlation with the motor speed. If the power source supplying the DC voltage to the motor has sufficient hysteresis, a sudden change in the mechanical load to the motor will result in a measurable voltage change at the motor leads. A sudden droop in this voltage is indicative of a sudden increase in motor torque load, as that which would occur if the door were to encounter an obstruction. Increased motor current and eventual recovery of the power supply will rapidly bring the motor back to the nominal speed, but it is the instantaneous change in voltage which occurred during the interim that is of interest. The amount of change can be quantified in two ways. With a first method, one can take the derivative of the voltage (dv/dt) by sensing the peak voltage across a resistor which is series-connected to a capacitor, both of which are in parallel with the motor windings. The second way is to sense the discrete magnitude of the motor voltage and set an adjustable voltage detector to capture it when it falls below a certain value. This second method can be carried out in various ways such as, for example, by using a circuit 124 of FIG. 13.

Circuit 124 monitors the voltage applied to a DC motor 126 that can be the prime mover of drive unit 36. Motor 126 is powered by a DC motor voltage 128 that can be supplied by a conventional DC supply. To filter out high frequency motor noise that could cause a false trip signal, a resister 146 and a capacitor 148 integrate motor voltage 128 to apply a filtered motor voltage signal at a negative input 150 of a conventional voltage comparator 134. A positive adjustable reference voltage 130 is fed into a positive input 132 of comparator 134.

In normal operation, motor voltage 128 is of higher positive potential than reference voltage 130, which keeps an output 136 of comparator 134 at virtual zero potential, whereby a coil 138 of a relay 140 is de-energized to leave the relay's normally open contacts 142 open. When the door's mechanical load increases suddenly due to encountering an obstruction, motor voltage 128 will decrease. If the load is sufficient to lower motor voltage 128 to less than reference voltage 130, then output 136 of comparator 134 will energize coil 138 to close contacts 142. Contacts 142 can be used to stop or reverse the drive unit 36 by sending an overload signal (e.g., signal 66) to a motor controller (e.g., controller 62). A potentiometer 144 can be used to set reference voltage 130 for the desired sensitivity of the door's response to an obstruction. The closer that reference voltage 130 is set to the motor voltage 128, the more sensitive will be the response or the less the motor speed will have to drop to trigger the overload signal.

Although the invention is described with reference to a preferred embodiment, it should be appreciated by those skilled in the art that various modifications are well within the scope of the invention. It should be noted that the terms “right-hand” and “left-hand” were chosen to help make the written description easier to visualize than if the equivalent terms of “first” and “second” were used. It should be clear that inverting various elements, interchanging right-hand and left-hand elements, mirror images and horizontal to vertical rotations of the illustrated embodiments are well within the scope of the invention. Therefore, the scope of the invention is to be determined by reference to the claims that follow.

1. A door for at least partially covering a doorway, the door comprising:
a first door panel movable across the doorway between an open position and a closed position;
a flexible elongate member coupled to the first door panel to move the first door panel between the open position and the closed position;
a drive unit connected to the flexible elongate member and being selectively operable in an opening mode where the drive unit enables the first door panel to move toward the open position, a closing mode where the drive unit enables the first door panel to move toward the closed position, and a stop mode where the drive unit holds the first door panel substantially stationary; and
a sensor in sufficient proximity with the flexible elongate member to sense tension therein, wherein the sensor provides an overload signal in response to the tension reaching a predetermined limit indicative of the first door panel being obstructed, and wherein the drive unit responds to the overload signal by changing from the closing mode to one of the opening mode and the stop mode.

2. The door of claim 1, wherein the first door panel moves horizontally between the open position and the closed position.

3. The door of claim 1, wherein the sensor provides the overload signal in response to the tension decreasing to the predetermined limit.

4. The door of claim 1, wherein the sensor senses the tension in the flexible elongate member by sensing the slackness of the flexible elongate member.

5. The door of claim 4, wherein the sensor is a proximity sensor that detects whether the flexible elongate member has moved to a certain distance from the proximity sensor.

6. The door of claim 1, wherein the flexible elongate member has a first section that is more elastic than a second section.

7. The door of claim 6, wherein the first section is a strap, and the second section is a chain.

8. The door of claim 6, wherein the first section is a cord, and the second section is a chain.

9. The door of claim 6, wherein the first section includes a spring.

10. The door of claim 1, wherein the sensor is connected inline with the flexible elongate member.

11. The door of claim 1, wherein the sensor senses tension in the flexible elongate member by sensing a change in length of at least a portion of the flexible elongate member.

12. The door of claim 1, further comprising a spring-loaded wheel that supports the flexible elongate member, wherein the sensor senses tension in the flexible elongate member by sensing translation of the spring-loaded wheel.

13. The door of claim 1, further comprising a second door panel connected to the flexible elongate member and being movable across doorway, wherein the first panel and the second panel move in opposite directions.

14. A door for at least partially covering a doorway, the door comprising:
a first door panel movable across the doorway between an open position and a closed position;
a left-hand wheel;
a right-hand wheel;
a flexible elongate member comprising a left-hand loop supported by the left-hand wheel, and a right-hand loop supported by the right-hand wheel, wherein the left-hand loop includes a left-hand opening leg and a left-hand closing leg, and the right-hand loop includes a right-hand opening leg and a right-hand closing leg, the left-hand opening leg and the right-hand closing leg are coupled to the first door panel to open and close the door respectively, and the left-hand closing leg and the right-hand opening leg are coupled to each other;
a drive unit operatively connected to the flexible elongate member to vary a closing tension in the right-hand closing leg and to vary an opening tension in the left-hand opening leg, wherein the drive unit is selectively operable in an opening mode, a closing mode, and a stop mode, wherein the opening tension is greater than the closing tension when the drive unit is in the opening mode whereby the left-hand opening leg pulls the first door panel toward the open position, and the closing tension is greater than the opening tension when the drive unit is in the closing mode whereby the right-hand closing leg pulls the first door panel toward the closed position, and the first door panel is held substantially stationary when the drive unit is in the stop mode; and
a sensor in sufficient proximity with the flexible elongate member to sense tension therein and to create an overload signal in response to the tension in the flexible elongate member reaching a predetermined limit, wherein the drive unit switches from the closing mode to one of the opening mode and the stop mode in response to the overload signal.

15. The door of claim 14, further comprising a second door panel coupled to the right-hand opening leg and the left-hand closing leg for respectively opening and closing the door.

16. The door of claim 14, wherein the first door panel moves horizontally between the open position and the closed position.

17. The door of claim 14, wherein the sensor provides the overload signal in response to the tension decreasing to the predetermined limit.

18. The door of claim 14, wherein the sensor senses the tension in the flexible elongate member by sensing the slackness of the flexible elongate member.

19. The door of claim 18, wherein the sensor senses the slackness in the right-hand opening leg.

20. The door of claim 14, wherein the sensor is a proximity sensor that detects whether the flexible elongate member has moved to a certain distance from the proximity sensor.

21. The door of claim 14, wherein the right-hand closing leg is more flexible than the right-hand opening leg.

22. The door of claim 21, wherein the right-hand closing leg is a strap, and the right-hand opening leg is a chain.

23. The door of claim 21, wherein the right-hand closing leg is a cord, and the right-hand opening leg is a chain.

24. The door of claim 21, wherein the right-hand closing leg includes a spring.

25. The door of claim 14, wherein the sensor is connected inline with the flexible elongate member.

26. The door of claim 14, wherein the sensor senses tension in the flexible elongate member by sensing a change in length of at least a portion of the flexible elongate member.

27. The door of claim 14, further comprising a spring-loaded wheel that supports the flexible elongate member, wherein the sensor senses tension in the flexible elongate member by sensing translation of the spring-loaded wheel.

28. A method of selectively moving a door panel to a closed position and an open position relative to a doorway, comprising:
using a flexible elongate cable to move the door panel toward the closed position;
sensing tension in the flexible elongate member; and
discontinuing the movement-of the door panel toward the closed position in response to sensing the tension in the flexible elongate member.

29. The method of claim 28, wherein the step of discontinuing the movement of the door panel toward the closed position is in response to the tension in the flexible elongate member decreasing to a predetermined limit.

30. The method of claim 28, wherein the step of discontinuing the movement of the door panel toward the closed position is in response to the tension in the flexible elongate member increasing to a predetermined limit.

31. The method of claim 28, wherein the step of sensing the tension in the flexible elongate member is achieved by detecting the slackness of the elongate member.

32. The method of claim 31, further comprising using a proximity sensor for detecting the slackness of the elongate member.
